(19) United States
(12) Patent Application Publication
(10) Pub. No.: US 2003/0229484 A1
(43) Pub. Date: Dec. 11, 2003

(54) Method and apparatus for simulating conditional branch instructions in a simulator which implies binary translation

(76) Inventors: Igor Liokumovich, Netanya (IL); Rinat Rappoport, Haifa (IL); Konstantin Levit-Gurevich, Kiryat Byalik (IL); Roman Fishtein, Haifa (IL)

Correspondence Address: FISH & RICHARDSON, PC, 4350 LA JOLLA VILLAGE DRIVE, SUITE 500, SAN DIEGO, CA, 92122, US

(21) Appl. No.: 10/165,853

(22) Filed: Jun. 7, 2002

(51) Int. Cl. G06F 9/45

(52) U.S. Cl. 703/22; 717/136

(57) ABSTRACT

In an embodiment, a binary translator translates instructions from a simulated instruction set into instructions from a host instruction set for execution on a host processor. The binary translator may translate a simulated conditional branch instruction into a set of host branch instructions. The binary translator may substitute a host target address for a simulated target address in a selected host branch instruction for an in-page conditional branch instruction.

### BACKGROUND

The instruction set architecture (ISA) of a new processor, e.g., a CPU (Central Processing Unit), is often developed on a simulator before a prototype of the processor is built. The simulator may be a computer program which executes the instruction set of a processor. The ISA of a target processor may be different than the ISA of a host processor on which the simulator runs. A user may evaluate the ISA by executing benchmark tests on the host machine which runs the simulator. Based on the results produced by the simulator, a user may verify or modify the new processor design accordingly.

Simulators may use binary translation. A binary translator may translate a target machine instruction into one or more host machine instructions. These allow the simulated program (after translation) to execute natively, i.e., directly on the host processor. It may be desirable to reduce the number of times that the binary translator is invoked during a simulation in order to increase the speed of the simulation. The simulator may invoke the binary translator only for a part of the application which is actually executed.

### BRIEF DESCRIPTION OF THE DRAWINGS

FIG. 1 is a block diagram of a simulator including a binary translator according to an embodiment.

FIGS. 2A-D are flowcharts describing a binary translation operation according to an embodiment.

### DETAILED DESCRIPTION

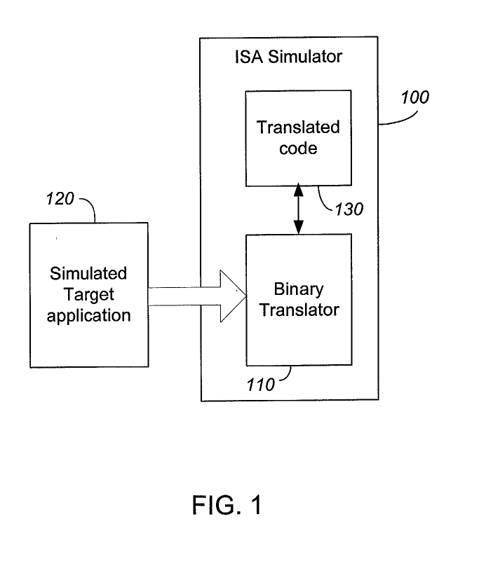

FIG. 1 illustrates a simulator 100 according to an embodiment. The simulator 100 may be used to simulate instructions of a target instruction set architecture (ISA).

A binary translator 110 is one of the simulator modules which translates a target machine (binary) code into host machine code. A simulator with binary translation may be used to develop a new ISA on existing processor architecture or to run a legacy ISA on a processor with a new architecture. The target ISA may be, for example, a future extension of IA32. IA32 is the ISA used in the Intel x86 compatible series of microprocessors.

A user may invoke the simulator 100 to execute a simulated target application 120. The binary translator 110 may simulate an IA32 instruction in the simulated application 120 by decoding the original (target) instruction and translating which instruction into one or more host processor instructions. The instructions which are executed on a host processor simulate the original instruction. For efficiency, the binary translator may translate a sequence of original instructions in one pass and only then execute the translated code. Such a sequence of original instructions is called a basic block. Target machine instructions may be translated one block at a time and then stored as translated code 130. Techniques to divide the original code into basic blocks may be based on page boundaries and/or branch instructions. Once translated, a basic block may be executed natively on the host processor an unlimited number of times.

A page is a fixed-size block of memory. Virtual memory includes the memory available for an application which is executed by a processor. For every instruction which requires an access to memory, a central processing unit (CPU) may translate a virtual memory address to a physical memory address. A page is the basic unit of physical memory. A CPU has a single translation entry for each virtual page. For all the memory addresses which are part of the same virtual page, a CPU may use the same translation entry to get the address of a physical page.

In order to simulate a memory access from the translated code, the simulator 100 may provide a translation from a simulated virtual address to a simulated physical address according to the ISA address translation process. Further, the simulator 100 may convert a simulated physical address to a host memory address which may be used for the actual memory access. A page is the unit of such an address translation process.

A branch instruction may cause a program to jump out of sequence. A program counter (also referred to as an instruction pointer) points to the current instruction to be executed in a program, and is generally incremented to the next sequential instruction in the program during normal program flow. A branch instruction may cause the program counter to jump to an out-of-sequence instruction elsewhere in the code. An unconditional branch instruction is often called a jump instruction, which moves the program counter to an instruction having an address specified in a destination operand. A conditional branch instruction moves the program counter to a destination instruction address if a condition is met and allows the program counter to fall through to the next sequential address if the condition is not met. Many times the condition tested by a conditional branch instruction is a comparison, such as equality and inequality tests, and comparisons with zero. For many programs, conditional branches account for a significant amount (up to 20%) of executed instructions.

The simulator 100 may simulate an original conditional branch instruction by checking the instruction's condition and determining if the condition is met. If the condition is true, the branch is taken and the simulator calculates the effective address of the destination simulated instruction. The simulator may then check the validity of the destination address. This validity check includes determining whether the destination address is in-segment and other checks required by the simulated ISA. If the address is valid, then the simulator may convert the destination's effective address to a physical address and then to an actual (host) address. The binary translator may also translate the basic block at the destination address. The program counter then jumps to the actual address of a “taken” basic block. If the condition is false, the branch is not taken and the destination address is the effective address of the next instruction. The same process of address conversion and binary translation is done with that instruction. The program counter then jumps to the actual target address of a “not taken” basic block. Thus, an original conditional branch instruction may lead execution to two target addresses: the next instruction if the condition is false (address of the “not-taken” basic block); and the branch target address if the condition is true (address of the “taken” basic block).

The simulator 100 may utilize a technique which enables in-page conditional branch instructions to be executed natively, i.e., directly on the host processor. The technique may improve the performance of the simulator 100 because costly page address translation may be done only once and costly transitions from the translated code to the simulator and back may be eliminated.

A conditional branch may be considered to be “in-page” if the taken target address or the not-taken target addresses are in the same page as the original instruction. When the branch is in-page, there is no need to detect a page-fault exception, which may occur when an attempt is made to access code or data in a page of memory which is not currently resident in the physical memory (RAM). Also, when the branch is in-page, there is no need to perform the page address translations required for out-of-page jumps.

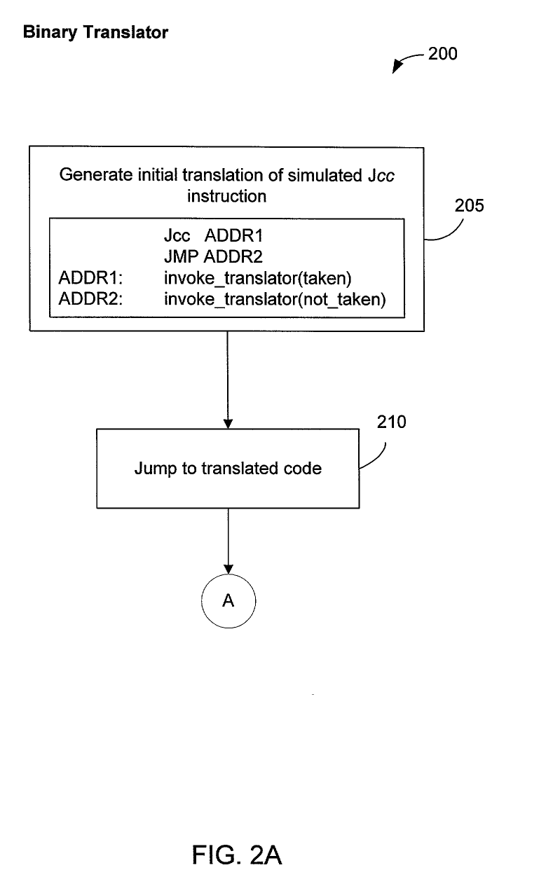

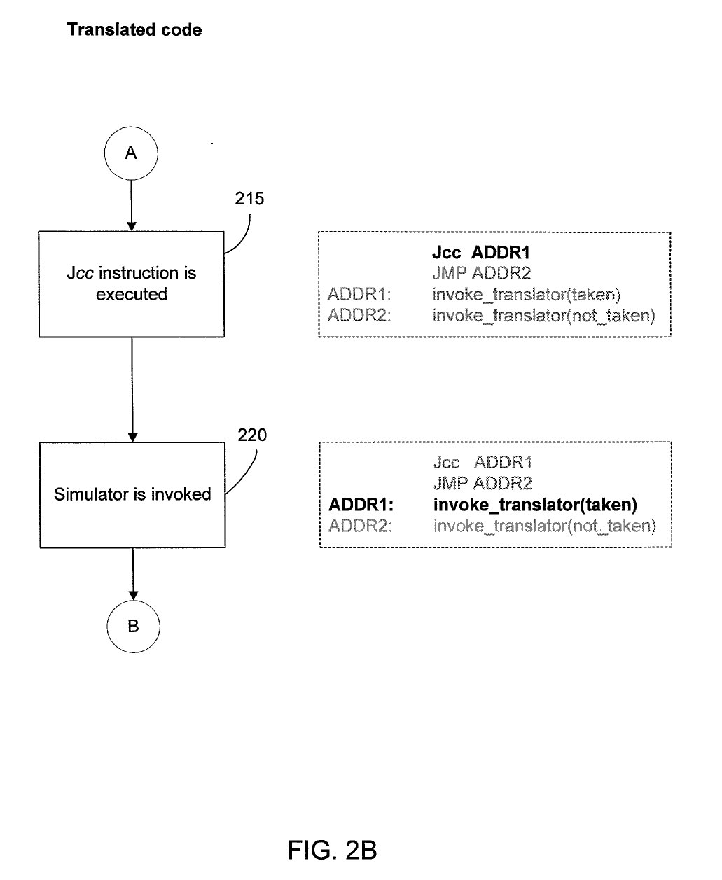

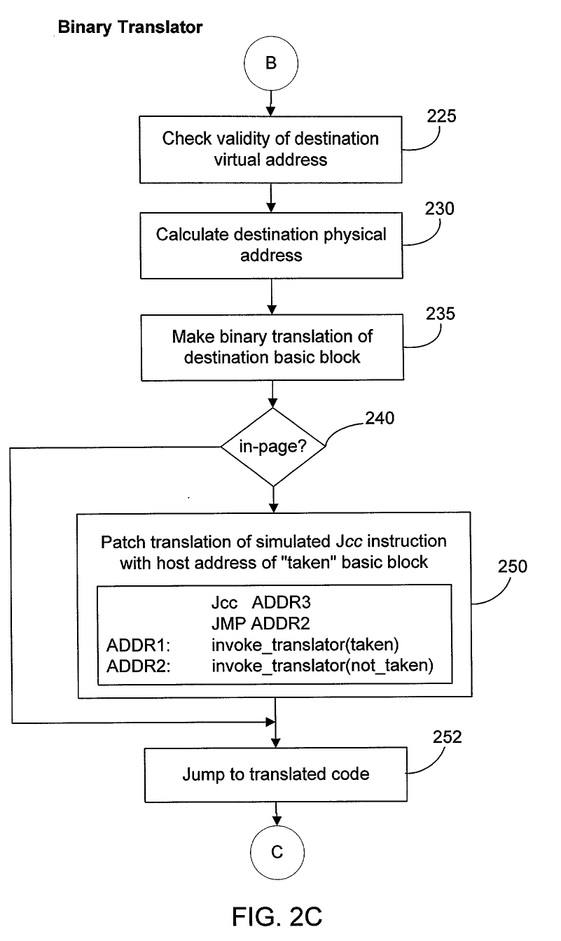

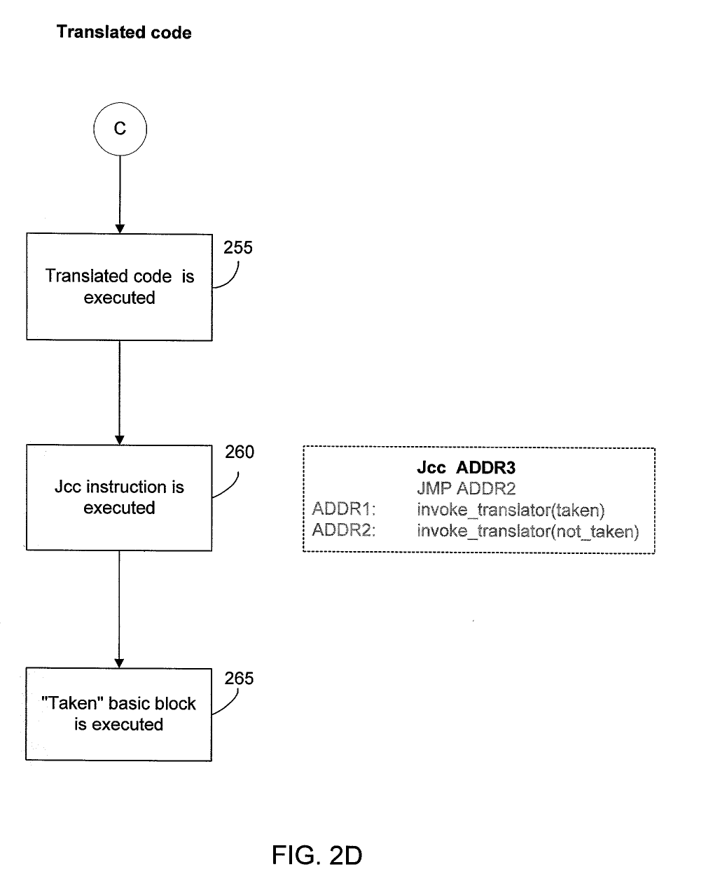

FIGS. 2A-2D are flowcharts describing an operation 200 for simulating in-page conditional instructions according to an embodiment. An original conditional branch instruction, generally denoted Jcc in IA32, is fetched and translated (block 205). An original conditional branch instructions may be translated into the following sequence of instructions:

JC ADDR1

JMP ADDR2

| | |
|---|---|
| ADDR1: | invoke_translator(taken) |
| ADDR2: | invoke_translator(not_taken) |

The simulator 100 begins execution of the translated code from a basic block containing the conditional branch instruction (block 210). In the present example, the condition for the Jcc instruction is met and the Jcc instruction is executed (block 215). The simulator 100 is invoked (block 220) and checks the validity of the destination address (block 225). If the destination address is valid, the simulator converts the destination's effective address to a physical address (block 230) and then to an actual (host) address. The binary translator also translates the basic block at the destination address (block 235) as the simulator is going to execute it.

The binary translator determines if the taken target address is in-page (block 240). If not (i.e. simulator should again check the destination address validity on next execution of the Jcc instruction), the program counter jumps to the translated code (block 252). If the taken target address is in-page, the binary translator patches the target address into the translation of the simulated Jcc instruction (block 250). The new branch destination address is the host address of the translated “taken” basic block (ADDR3). Then the simulator jumps to the translated code (block 252) and the translated code, i.e. the “taken” basic block, is executed (block 255). The next time the Jcc instruction is executed (block 260), the program counter directly jumps to the “taken” basic block, which is executed (block 265) without invoking the simulator.

As described above, an in-page conditional branch instruction may be executed natively with only a single simulator invocation for every actually executed path, which saves expensive IA32 architecture exception checks for the branch target address. Since the original conditional branch instruction is used to perform the condition check, it may be unnecessary to include additional specific code which checks the EFLAGS register for the condition.

A number of embodiments have been described. Nevertheless, it will be understood which various modifications may be made without departing from the spirit and scope of the invention. For example, blocks in the flowchart may be skipped or performed out of order and still provide desirable results. Accordingly, other embodiments are within the scope of the following claims.

1. A method comprising:
translating a simulated conditional branch instruction into a plurality of host branch instructions;
selecting one of said host branch instructions in response to a condition check, said selected host branch instruction including a simulated target address;
translating the simulated target address into a host target address; and
substituting the host target address for the simulated target address in the selected host branch instruction.

2. The method of claim 1, further comprising determining whether the simulated target address and the simulated conditional branch instruction are in a same memory block.

3. The method of claim 2, wherein said substituting the host target address for the target address is carried out in response to the simulated target address and the simulated conditional branch instruction being in the same memory block.

4. The method of claim 1, wherein the memory block comprises a page of memory.

5. The method of claim 1, wherein said translating comprises translating the simulated conditional branch instruction into a host conditional branch instruction and a host jump instruction.

6. The method of claim 1, wherein the host target address points to a basic block.

7. The method of claim 6, wherein the selected host branch instruction comprises a host conditional branch instruction, and wherein the host target address points to a taken basic block.

8. The method of claim 6, further comprising translating the basic block.

9. Apparatus comprising:
a processor operative to execute a set of host instructions including host branch instructions; and
a binary translator operative to translate a simulated conditional branch instruction into a plurality of host branch instructions and to substitute a host target address for a simulated target address in a selected branch instruction.

10. The apparatus of claim 9, wherein the binary translator is further operative to determine whether the simulated conditional branch instruction and the simulated target address are in a same memory block.

11. The apparatus of claim 9, wherein the binary translator is further operative to substitute the host target address for the simulated target address in response the simulated conditional branch address and the simulated target address being in the same memory block.

12. The apparatus of claim 9, wherein the memory block comprises a page.

13. The apparatus of claim 9, wherein the plurality of host branch instructions include a host conditional branch instruction and a host jump instruction.

14. The apparatus of claim 9, wherein the host target address points to the basic block and the binary translator is further operative to translate the basic block.

15. An article comprising a machine-readable medium including machine-executable instructions, the instructions operative to cause a machine to:
translate a simulated conditional branch instruction into a plurality of host branch instructions;
select one of said host branch instructions in response to a condition check, said selected host branch instruction including a simulated target address;
translate the simulated target address into a host target address; and
substitute the host target address for the simulated target address in the selected host branch instruction.

16. The article of claim 14, further comprising instructions operative to cause the machine to determine whether the simulated target address and the simulated conditional branch instruction are in a same memory block.

17. The article of claim 15, wherein said the instructions for substituting the host target address for the target address are conditional upon the simulated target address and the guest conditional branch instruction being in the same memory block.

18. The article of claim 14, wherein the memory block comprises a page.

19. The article of claim 14, wherein the instructions for translating include instructions operative to cause the machine to translate the simulated conditional branch instruction into a host conditional branch instruction and a host jump instruction.
